(19) United States
(12) Patent Application Publication
(10) Pub. No.: US 2016/0096511 A1
(43) Pub. Date: Apr. 7, 2016

(54) WIPER BLADE DEVICE AND WIPER DEVICE FOR CONNECTING A WIPER BLADE TO A WIPER ARM OF A VEHICLE

(71) Applicant: Valeo Systèmes d'Essuyage, Le Mesnil Saint Denis (FR)

(72) Inventors: Giuseppe Grasso, Le Breuil sur Couze (FR); Denis Thebault, Clermont Ferrand (FR); Michael Schaeuble, Vaihingen/enz (DE)

(73) Assignee: Valeo Systèmes d'Essuyage, Le Mesnil Saint Denis (FR)

(21) Appl. No.: 14/872,310

(22) Filed: Oct. 1, 2015

(30) Foreign Application Priority Data
Oct. 2, 2014 (EP) 14306554.8

(51) Int. Cl. B60S 1/40; B60S 1/52

(52) U.S. Cl. CPC B60S 1/4048; B60S 1/522; B60S 1/4041; B60S 2001/4054

(57) ABSTRACT

The invention relates to a wiper blade device for a wiper device for connecting a wiper blade to a wiper arm of a vehicle, comprising an adapter configured to be connected to a wiper arm device and a blade connector configured to be connected to a wiper blade, said adapter and blade connector being arranged pivotably with respect to each other in a rotation axis destined to be perpendicular to the longitudinal direction of the wiper blade, wherein a fluid channel is arranged into the adapter, the fluid channel having an inlet destined to be plugged-in a water hose and ending by at least one spray nozzle enabling the spraying of a washing fluid.

The invention relates to a wiper blade device for a wiper device for connecting a wiper blade to a wiper arm of a vehicle. The invention further relates to a wiper device.

A wiper device for connecting a wiper blade with a wiper arm comprising a wiper blade adapter having an adapter element on the wiper arm side and an adapter element on the wiper blade side, which are arranged pivotably with respect to each other in a rotation axis is known from prior art. This allows having a high rotation amplitude of the wiper blade with respect to the wiper arm.

The wiper blade is made of two wiper blade sections, each having spray ducts constructed inside, which are connected to the wiper blade adapter. The wiper blade adapter is connected to a supply line for the washing fluid which is guided along the wiper arm on the vehicle side.

One aim of the present invention is to provide a wiper blade device with a washing fluid spraying function for a wiper blade which has no internal spray ducts in a compact assembly.

This object is achieved by a wiper blade device for connecting a wiper blade to a wiper arm of a vehicle, comprising an adapter configured to be connected to a wiper arm and a blade connector configured to be connected to a wiper blade, said adapter and blade connector being arranged pivotably with respect to each other in a rotation axis destined to be perpendicular to the longitudinal direction of the wiper blade, wherein a fluid channel is arranged into the adapter, the fluid channel having an inlet destined to be plugged-in a water hose and ending by at least one spray nozzle enabling the spraying of a washing fluid.

Thus, the wiper blade device allows connecting the wiper blade to the wiper arm and allows providing a spraying function. The spraying function inserted in the adapter is thus well integrated near the rotation axis. This allows providing a compact wiper device while spraying the washing fluid directly on the surface that is swept by the wiper blade.

The wiper blade device may further comprise one or more features hereafter, taking alone or in combination:
the rotation axis comprises a pivot pin around which the adapter and the blade connector are arranged pivotably,
the at least one spray nozzle is arranged on a protrusion of the adapter, arranged on the side wall of a main body of the adapter,
the fluid channel comprises an intermediate fluid portion which extends in a direction parallel to the rotation axis,
the fluid channel comprises an intermediate fluid portion which extends in a direction aligned with the rotation axis,
the wiper blade device comprises a closure element inserted between the fluid channel and the pivot pin,
the fluid channel comprises an intermediate fluid portion which is arranged between the rotation axis and a front cover of the adapter,
the at least one spray nozzle is arranged in the front cover,
the fluid channel comprises an inlet fluid portion communicating between the inlet and the intermediate fluid portion which is destined to be arranged in parallel with the longitudinal direction of the wiper blade,
the adapter is configured to cooperate with complementary connecting elements of the wiper arm device to connect the wiper arm device with the wiper blade device after two movements of the wiper blade device perpendicularly with respect to each other,
the complementary connecting elements of the wiper arm device comprise at least two connecting lugs arranged on each side wall of the wiper arm device,
the adapter comprises complementary slots or boundaries extending perpendicularly to the longitudinal direction, and notches extending in the longitudinal direction at an end of the slots or boundaries, the connecting lugs being able to cooperate with the complementary slots or boundaries and notches to connect the wiper arm device with the wiper blade device after two movements of the wiper blade device perpendicularly with respect to each other.

Another object of the present invention is a wiper device for connecting a wiper blade to a wiper arm of a vehicle, wherein it comprises a wiper arm device destined to be connected to a wiper arm and a wiper blade device as previously described, destined to be connected to a wiper blade.

The spray nozzles may be arranged on a side of the front end of the assembled wiper device.

Further advantages, features and details of the invention will be apparent from the following description of preferred example embodiments and with the aid of the drawings, showing in:

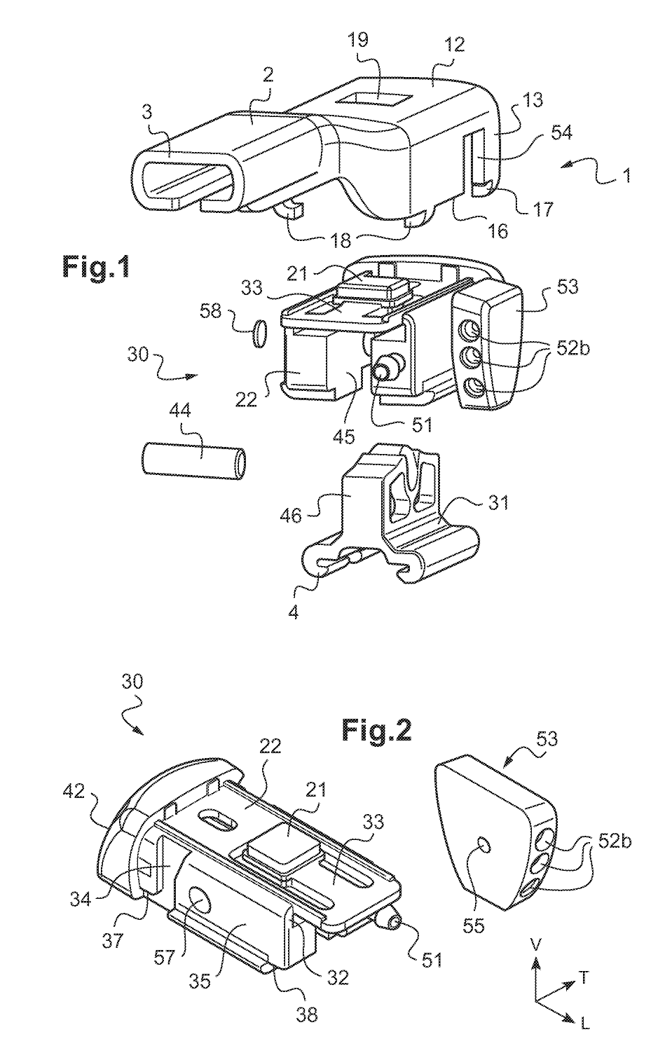

FIG. 1, a perspective rear view of a disassembled wiper device according a first embodiment,

FIG. 2, a perspective view of an adapter of the wiper blade device, having a main body and a protrusion in a disassembled state,

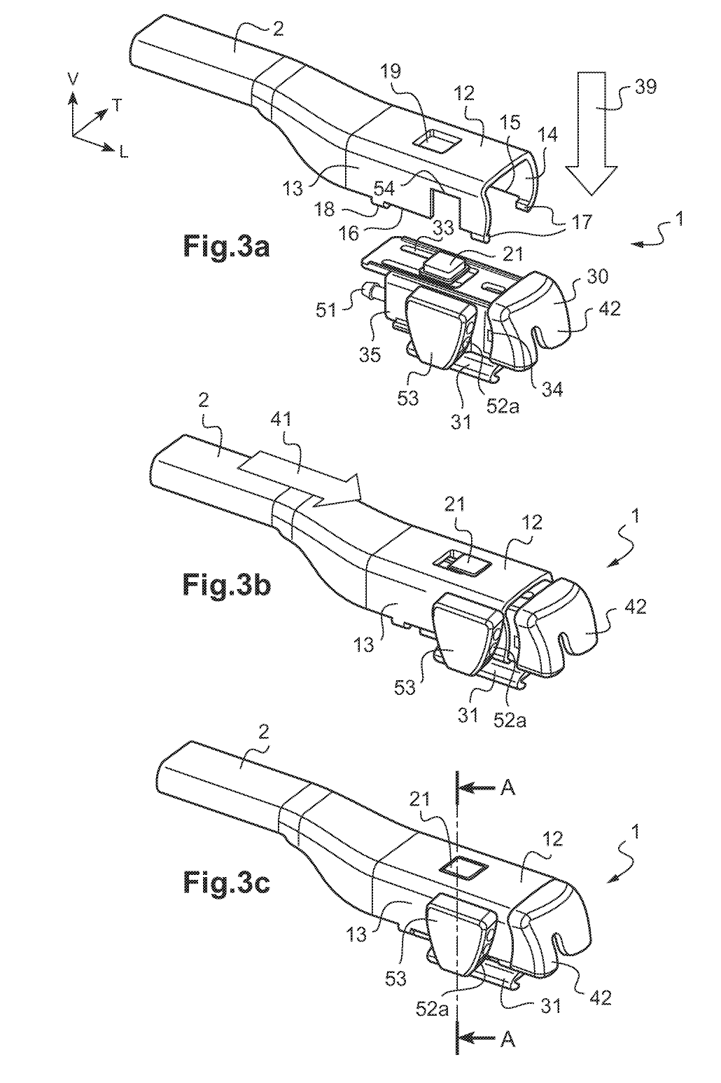

FIG. 3a, a perspective side view of the wiper device of FIG. 1, the wiper blade device being assembled and the wiper arm device being plumb with the wiper blade device,

FIG. 3b, a step of the wiper device mounting following the step shown on FIG. 3a, wherein the wiper arm device and the wiper blade device have been moved towards each other in a vertical direction,

FIG. 3c, a step of the wiper device mounting following the step shown on FIG. 3b, wherein the wiper arm device and the wiper blade device have been moved towards each other in the wiper blade longitudinal direction,

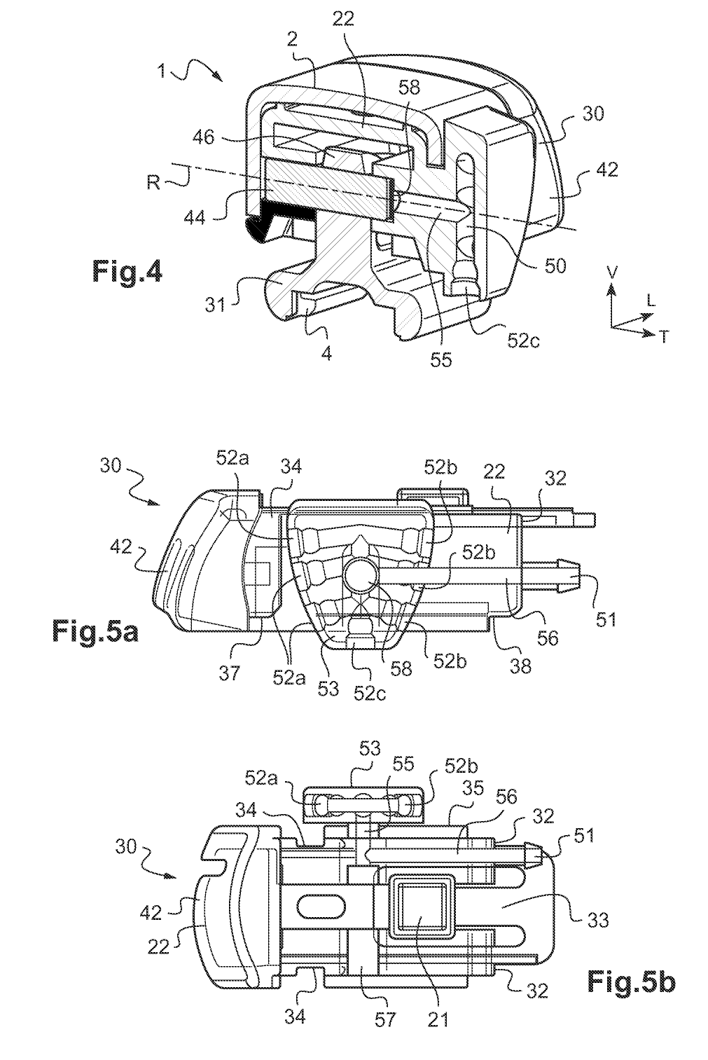

FIG. 4, a section in the direction of the plane A-A of FIG. 3c,

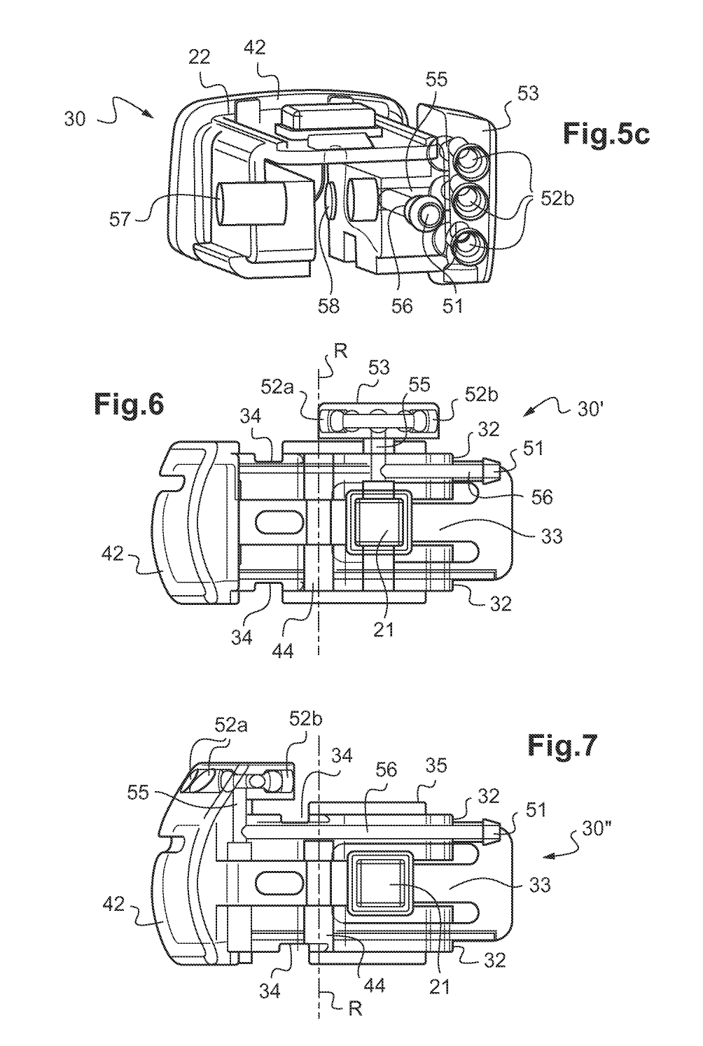

FIG. 5a, a perspective side view of the adapter, the body of which being seen by transparency,

FIG. 5b, a similar view of the adapter of FIG. 5a, in a top view,

FIG. 5c, a similar view of the adapter of FIG. 5a, in a rear view,

FIG. 6, a top view of the adapter according to a second embodiment, the body of which being seen by transparency,

FIG. 7, a top view of the adapter according to a third embodiment, the body of which being seen by transparency,

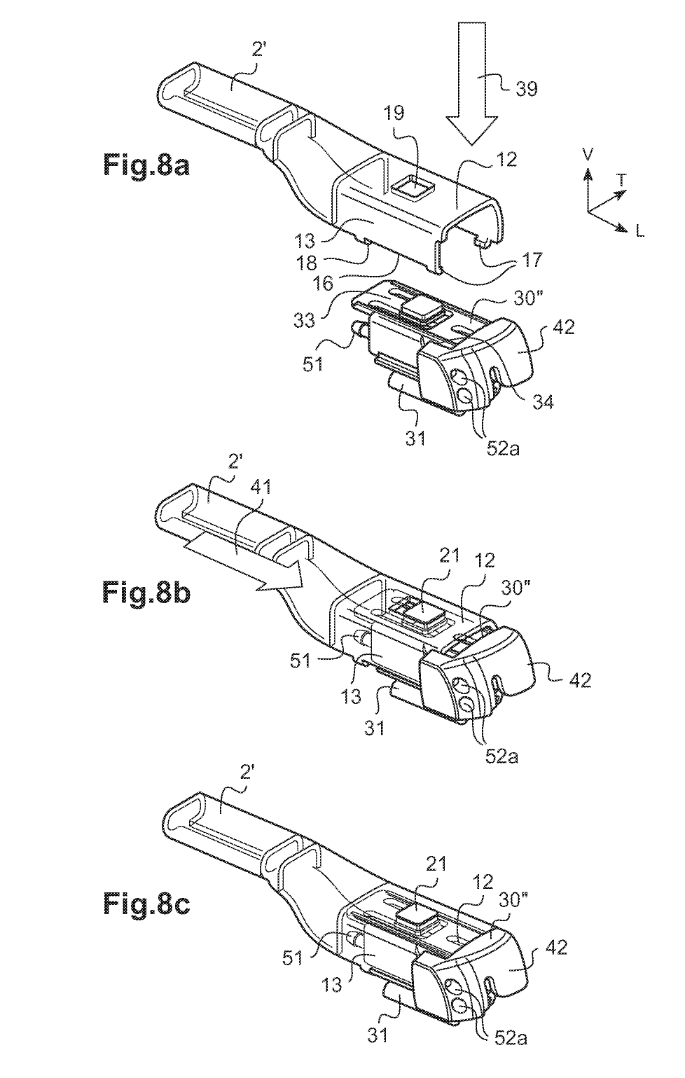

FIG. 8a, a perspective side view of a wiper device according the third embodiment, the wiper arm device being plumb with the wiper blade device,

FIG. 8b, a step of the wiper device mounting following the step shown on FIG. 8a, wherein the wiper arm device and the wiper blade device have been moved towards each other in a vertical direction, and

FIG. 8c, a step of the wiper device mounting following the step shown on FIG. 8b, wherein the wiper arm device and the wiper blade device have been moved towards each other in the wiper blade longitudinal direction,

Identical components or respectively components with the same function are provided with the same reference numbers in the figures.

In the description, will be adopted without limitation to the longitudinal, vertical and transverse directions as shown in figures by the system (L, V, T) fixed relative to the wiper device 1. The longitudinal direction L corresponds to the main direction of the wiper blade. As the wiper device is shown, the horizontal plane corresponds to the plane (L, T). Directions “up” and “down” are designated with reference to the orientation of the wiper device in FIGS. 3a, 8a. Direction “front” is designated with reference to the free end side of the wiper arm.

FIGS. 1, 2, 3a, 3b, 3c, 4, 5a, 5b and 5c show a first embodiment of a wiper device 1 for connecting a wiper blade (not shown) to a wiper arm (not shown) of a vehicle. As it can be seen on FIG. 1, the wiper device 1 comprises a wiper arm device 2 comprising an arm connector 3 destined to be mechanically connected to a wiper arm, and a wiper blade device destined to be mechanically connected to a wiper blade.

The wiper blade device comprises an adapter 30 configured to be mechanically connected to the wiper arm device 2 on the wiper arm side, and a blade connector 31 configured to be mechanically connected to the wiper blade, on the wiper blade side, for example by means of clips 4.

The adapter 30 and the blade connector 31 are arranged pivotably with respect to each other in a rotation axis R perpendicular to the longitudinal direction L of the wiper blade (FIG. 4). The rotation axis R may comprise a pivot pin 44 around which the adapter 30 and the blade connector 31 are arranged pivotably.

Better shown in FIGS. 3a, 3b, 3c, the adapter 30 is configured to cooperate with complementary connecting elements of the wiper arm device 2 to connect the wiper arm device 2 with the wiper blade device after two movements of the wiper blade device 2 perpendicularly with respect to each other.

In more detail, the wiper arm device 2 has a U-shaped cross-section on the side facing the wiper blade. The wiper arm device 2 has a rectangular base section 12 in the connecting region with the wiper blade device, on the opposite side of the arm connector 3. Side walls 13, 14 project from the base section 12 which are bent at right-angles in the direction of the wiper blade. In the illustrated example embodiment, the complementary connecting elements of the wiper arm device 2 comprise at least two connecting lugs 17, such as four lugs 17, 18 in the example, arranged on each side wall 13, 14 of the wiper arm device 2 having a U-shaped cross-section in the connecting region.

The connecting lugs 17, 18 may be integrally formed in one piece on the lower boundary edges 15, 16 of the side sections 13, 14, facing away from the base section 12. Whereas the ones connecting lugs 17 are aligned with the end or respectively the front face of the wiper arm device 2, the others connecting lugs 18 are arranged in longitudinal direction of the wiper arm device 2 spaced apart from the connecting lugs 17. The connecting lugs 17, 18 are bent around inwards at right-angles facing each others and in the example embodiment have a rectangular cross-section. In the base section 12 of wiper arm device 2, a rectangular cut-out is constructed in the form of an aperture 19. The aperture 19 cooperates with a detent button 21 of the adapter 30 of the wiper blade device.

The connection of the wiper blade device with the wiper arm device takes place via the adapter 30 on the wiper arm side, which cooperates with the wiper arm device 2 in a form- fitting and force-fitting manner. For this, the wiper device 1 is made of plastic, or respectively the adapter 30 has an elastic section 33, which can be seen in FIG. 2, at the free end of which the detent button 21 is arranged. In the position of the wiper blade device connected with the wiper arm device 2, the detent button 21 engages into the aperture 19 on the wiper arm device 2 in a form-fitting manner and positions the wiper arm device 2 in the wiper blade longitudinal direction L.

As it can be seen in FIGS. 1, 2 and 4, the adapter 30 comprises a main body 22 extending in the longitudinal axis L of the wiper blade. A cavity 45 arranged in the main body 22 is able to receive a corresponding bump 46 of the blade connector 31. The pivot pin 44 is passing through the cavity 45, the main body 22 and the bump 46 to enable the relative rotation between the adapter 30 and the blade connector 31.

The adapter 30 comprises complementary slots 34 or boundaries 32 (instead of longitudinal slots 34, corresponding grooves could also be provided), extending in the vertical direction V, perpendicularly to the longitudinal direction L, and notches 37, 38 extending in the longitudinal direction L, at the ends of the slots 34 or boundaries 32. The slots 34 or boundaries 32 are arranged on the side walls 35 of the main body 22 of the adapter 30 and notches 37, 38 are arranged at the lower boundary edges of the side walls 35.

The connecting lugs 17, 18 of the wiper arm device 2 are able to cooperate with the complementary slots 34 or boundaries 32 and notches 37, 38 to connect the wiper arm device 2 with the wiper blade device after two movements of the wiper blade device 2 perpendicularly with respect to each other.

A fluid channel 50 is arranged into the adapter 30 (FIGS. 4, 5a, 5b, 5c).

The fluid channel 50 has an inlet 51 destined to be plugged-in a water hose connected to a supply line of washing fluid which is guided along the wiper arm on the vehicle side, and ends by at least one spray nozzle 52a, 52b, 52c enabling the spraying of the washing fluid.

The plug-in can be done in a very simple way by hand.

The at least one spray nozzle 52a, 52b, 52c, may be arranged on a protrusion 53 of the adapter 30, arranged on a side wall 35 of the main body 22 of the first part adapter 30. The protrusion 53 is for example linked to the side wall 35 by means of a thin bridge and a complementary aperture 54 is arranged on the corresponding side wall 13 of the wiper arm device 2, allowing the passage of the bridge and the assembly of the adapter 30 with the wiper arm device 2. The protrusion 53, the bridge and the main body 22 can be integrally formed in one piece or made in distinct elements assembled for example by clipping (a form-fit connection), glue, ultrasonics, screws or warm caulking.

At least one spray nozzle 52a may be arranged in the front of the protrusion 53 while at least one other spray nozzle 52b is arranged in the backside of the protrusion 53. This enables the spray of washing fluid in front and back direction of the longitudinal direction L.

For example and as it can be better seen on FIG. 5a, three spray nozzles 52a may be arranged in front side and three other spray nozzles 52b are arranged backside. A supplementary spray nozzle 52c may also be arranged downwardly, enabling spraying washing fluid in the direction of the wiper blade. The front and back spray nozzles 52a, 52b can be superimposed and oriented towards the wiper blade with different inclination angles in order to increase the length which can be sprayed.

The fluid channel 50 may comprise an intermediate fluid portion 55 and an inlet fluid portion 56, which are, for example, perpendicular with respect to each other. The fluid channel 50 may comprise cylindrical channels.

The inlet fluid portion 56 communicates between the inlet 51 and the intermediate fluid portion 55. The inlet fluid portion 56 extends to a direction parallel to the longitudinal direction L of the wiper blade.

The intermediate fluid portion 55 extends in a direction parallel to the rotation axis R and crosses the bridge of the adapter 30 to connect the spray nozzles 52a, 52b, 52c of the protrusion 53 with the inlet fluid portion 56.

In a first embodiment, the intermediate fluid portion 55 extends in a direction aligned with the rotation axis R. In other words, the pivot pin 44 is coaxial with the cylindrical intermediate fluid portion 55. The protrusion 53 can thus be well centered on the side wall 35 of the main body 22 of the first part adapter 30.

A hole 57, for example a drilled hole, is made in the adapter 30, to form the intermediate fluid portion 55 and to receive the pivot pin 44. The hole 57 may be made after the assembly of the distinct elements when made by distinct elements. The adapter 30 may also comprise watertight seals (not shown) inserted between the distinct elements.

The wiper device 1 may further comprise a closure element 58 inserted between the fluid channel 50 and the pivot pin 44 to close the fluid channel 50. The closure element 58 may be made for example by a disc or a ball. It can be fixed in the fluid channel 50 for example by glue or ultrasonics.

Thus, the wiper blade device allows connecting the wiper blade to the wiper arm and providing a spraying function. The spraying function inserted in the adapter is thus well integrated near the rotation axis. This allows providing a compact wiper device while spraying the washing fluid directly on the surface that is swept by the wiper blade. Moreover, this connection does not prevent the bayonet closure by connecting lugs into slots of the wiper blade device. The compact wiper device is therefore also easy to assemble and disassemble.

According to a second embodiment represented on FIG. 6, the intermediate fluid portion 55 is arranged between the rotation axis R and a rear end of the adapter 30′. The intermediate fluid portion 55 is parallel to the rotation axis R and crosses the bridge of the adapter 30′ to make in communication the spray nozzles 52a, 52b, 52c of the protrusion 53 with the inlet fluid portion 56.

According to a third embodiment represented on FIGS. 7, 8a, 8b and 8c, the intermediate fluid portion 55 is arranged between the rotation axis R and a front cover 42 of the adapter 30″.

In this embodiment, the spray nozzles 52a, 52b, 52c may be arranged on a side of the front cover 42 of the main body 22 of the first part adapter 30″. Therefore, once assembled, the spray nozzles 52a are arranged on a side of the front end of the wiper device 1.

The spray nozzles 52a, 52b may be superimposed.

With this arrangement, the wiper arm device 2′ doesn't need to have complementary aperture 54 arranged on the side wall for assembling the adapter 30″.

As it can be seen on FIGS. 8a, 8b and 8c, the assembly steps can be the same as with the first and second embodiments shown on FIGS. 3a, 3b and 3c.

In accordance with FIGS. 3a and 8a, the wiper blade device is positioned to the wiper arm device 2; 2′ such that the connecting lugs 17 are aligned with the longitudinal slots 34 and with the boundaries 32. Subsequently, the wiper arm device 2; 2′ and the wiper blade device are moved towards each other in accordance with FIG. 3b; 8b in the direction of the arrow 39, so that the connecting lugs 17 engage into the longitudinal slots 34, whereas the other connecting lugs 18 slide along the boundaries 32 of the side walls 35.

When the connecting lugs 17, 18 are arranged at the height of the notches 37, 38, and the base section 12 of the connecting region lies on the upper side of the adapter 30′; 30″, the wiper blade device can be moved in the longitudinal direction L (arrow 41), i.e. sliding perpendicularly to the movement of introduction of the connecting lugs 17, 18 in the direction of the arrow 39, so that the connecting lugs 17, 18 arrive into the region of the notches 37, 38 and cooperate therewith, wherein the notches 37, 38 act as axial stops for the connecting lugs 17, 18. In the end position of the wiper blade device on the wiper arm device 2; 2′, the detent button 21 engages into the aperture 19 of the wiper arm device 2; 2′ and positions the wiper blade.

In addition, the base section 12 and the side sections 13, 14 are arranged on the one front face of the wiper arm device 2; 2′ in abutting contact with a front cover 42 of the adapter 30.

To release the wiper blade from the wiper arm, the described mounting steps take place in reverse order.

1. wiper blade device for connecting a wiper blade to a wiper arm of a vehicle, comprising:
an adapter configured to be connected to a wiper arm; and
a blade connector configured to be connected to a wiper blade, said adapter and blade connector being arranged pivotably with respect to each other in a rotation axis perpendicular to the longitudinal direction of the wiper blade,
wherein a fluid channel is arranged into the adapter, the fluid channel having an inlet configured destined to be plugged-in a water hose and ending by at least one spray nozzle enabling the spraying of a washing fluid.

2. The wiper blade device according to claim 1, wherein the rotation axis comprises a pivot pin around which the adapter and the blade connector are arranged pivotably.

3. The wiper blade device according to claim 1, wherein the at least one spray nozzle is arranged on a protrusion of the adapter, arranged on the side wall of a main body of the adapter.

4. The wiper blade device according to claim 1, wherein the fluid channel comprises an intermediate fluid portion which extends in a direction parallel to the rotation axis.

5. The wiper blade device according to claim 4, wherein the fluid channel comprises an intermediate fluid portion which extends in a direction aligned with the rotation axis or coaxial with the pivot pin.

6. The wiper blade device according to claim 5, wherein the device comprises a closure element inserted between the fluid channel and the pivot pin.

7. The wiper blade device according to claim 4, wherein the fluid channel comprises an intermediate fluid portion which is arranged between the rotation axis and a front cover of the adapter.

8. The wiper blade device according to claim 7, wherein the at least one spray nozzle is arranged in the front cover.

9. The wiper blade device according to claim 1, wherein the fluid channel comprises an inlet fluid portion communicating between the inlet and the intermediate fluid portion which is arranged in parallel with the longitudinal direction of the wiper blade.

10. The wiper blade device according to claim 1, wherein the adapter is configured to cooperate with complementary connecting elements of the wiper arm device to connect the wiper arm device with the wiper blade device after two movements of the wiper blade device perpendicularly with respect to each other.

11. The wiper blade device according to claim 10, wherein:
the complementary connecting elements of the wiper arm device comprise at least two connecting lugs arranged on each side wall of the wiper arm device, and
the adapter comprises complementary slots or boundaries extending perpendicularly to the longitudinal direction, and notches extending in the longitudinal direction at an end of the slots or boundaries, the connecting lugs being able to cooperate with the complementary slots or boundaries and notches to connect the wiper arm device with the wiper blade device after two movements of the wiper blade device perpendicularly with respect to each other.

12. A wiper device for connecting a wiper blade to a wiper arm of a vehicle, wherein the wpier device comprises a wiper arm device configured to be connected to a wiper arm and a wiper blade device according to claim 1, to be connected to a wiper blade.

13. The wiper device according to claim 12, wherein the spray nozzles are arranged on a side of the front end of the assembled wiper device.
